(19) United States
(12) Patent Application Publication
(10) Pub. No.: US 2011/0109096 A1
(43) Pub. Date: May 12, 2011

(54) Fixed pitch wind (or water) turbine with centrifugal weight control (CWC)

(76) Inventor: Matthew Earley, Allenwood, NJ (US)

(21) Appl. No.: 12/925,235

(22) Filed: Oct. 18, 2010

Related U.S. Application Data
(60) Provisional application No. 61/280,606, filed on Nov. 6, 2009.

(51) Int. Cl. F03D 9/02

(52) U.S. Cl. 290/55

(57) ABSTRACT

The Fixed Pitch Wind (Water) turbine is a more productive system than current technology in that it extracts increasing amounts of energy from wind (or water) flows throughout typical operating ranges (25 m/s for wind and 3.4 m/s for tidal). Further, an inherently stronger fixed pitch solution can have greater blade solidity that will, in turn increase torque across the entire operating range.

Extending the low speed shaft brings major and heavy system components to the tower base (for wind) or above water line (tidal) for reduced cost, both initially and on an ongoing basis.

The weight control system acts as a buffer for energy storage that will accommodate gusty or turbulent conditions and also facilitate gear changes as the speed of the rotor changes.

This non-provisional application does reference and claim benefit of an earlier provisional application having an Nov. 6, 2009 filing date and application No. 61/280,606.

### BACKGROUND OF INVENTION

The invention incorporates a unique and patented means of controlling rotor speed and is in lieu of traditional aerodynamic solutions (pitch or stall). In current systems pitch or stall in conjunction with generator torque is the typical solution for speed control. In the proposed system the weight scheme in conjunction with generator torque will control rotor speed.

### BRIEF SUMMARY OF INVENTION

The fixed pitch rotor and centrifugal weight control will permit the generation of increasing amounts of energy for the full distribution of operating speeds in both wind and water scenarios. Current technology captures and transforms less than half of the energy content available in the discussed distribution. In wind, operating speed is typically up to 25 m/s though rated power is typically reached at 14 or 15 m/s. In water, highest flow rate is typically 3.4 m/s though rated power is usually at 2.4 m/s. The table in FIG. 6 shows a 20-year projection for a 36-meter system with power totals at 15 m/s for current solution and 25 m/s for the discussed solution.

Further, this same weight control scheme permits use of a transmission (in lieu of gearbox). In so doing the rotor can continue to increase speed (rpm's) in an increasing flow (wind or water) while generator speed can be held constant via gear ratio reductions offered by the transmission.

### BRIEF DESCRIPTION OF THE SEVERAL VIEWS OF THE DRAWINGS AND TABLES

FIG. 1 Fixed Pitch Wind Turbine w/CWC

FIG. 2 Fixed Pitch Water Turbine w/CWC

FIG. 3 CWC System/Wind Implementation

FIG. 4 CWC Storage Calculations

FIG. 5 Nacelle top down view

FIG. 6 Power/Energy Tables

### DETAILED DESCRIPTION OF THE INVENTION

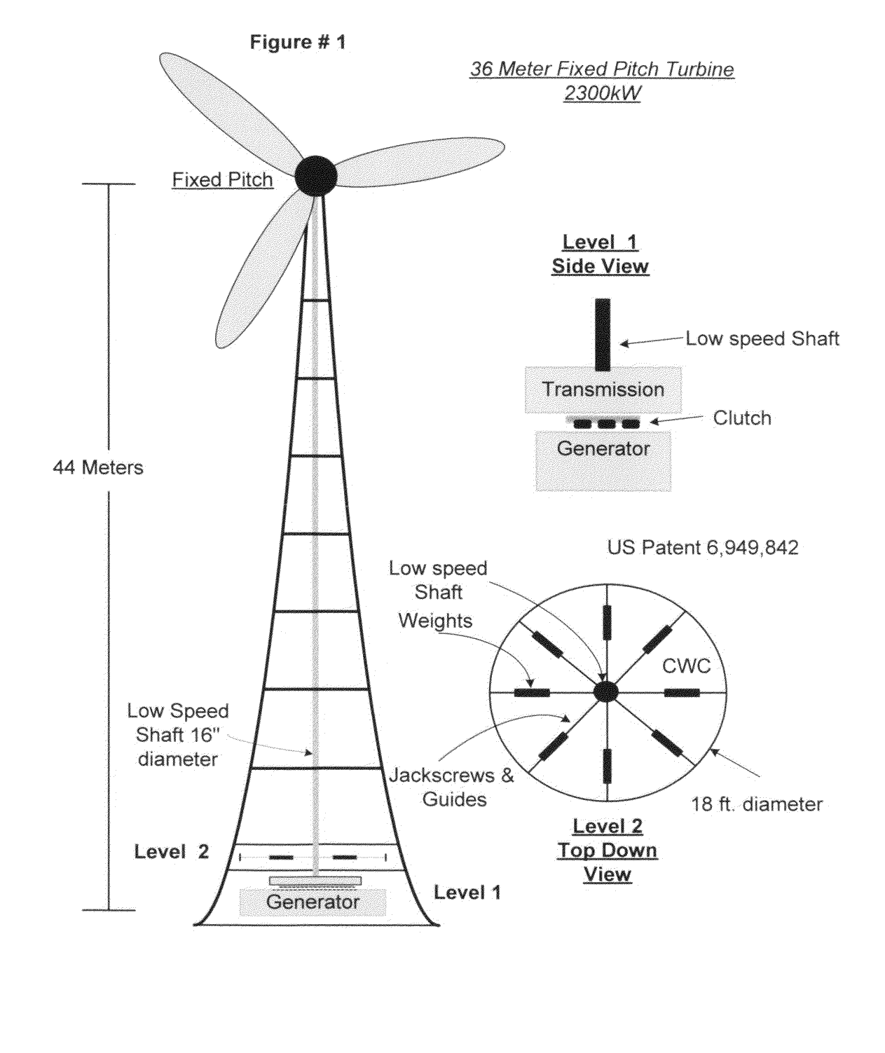

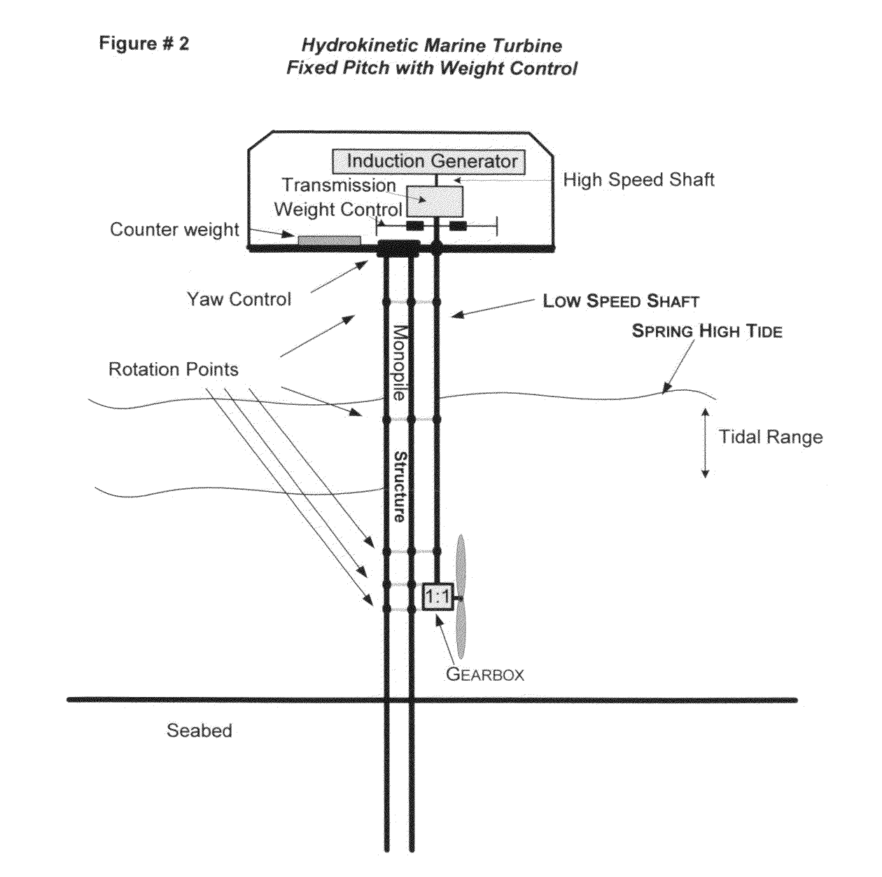

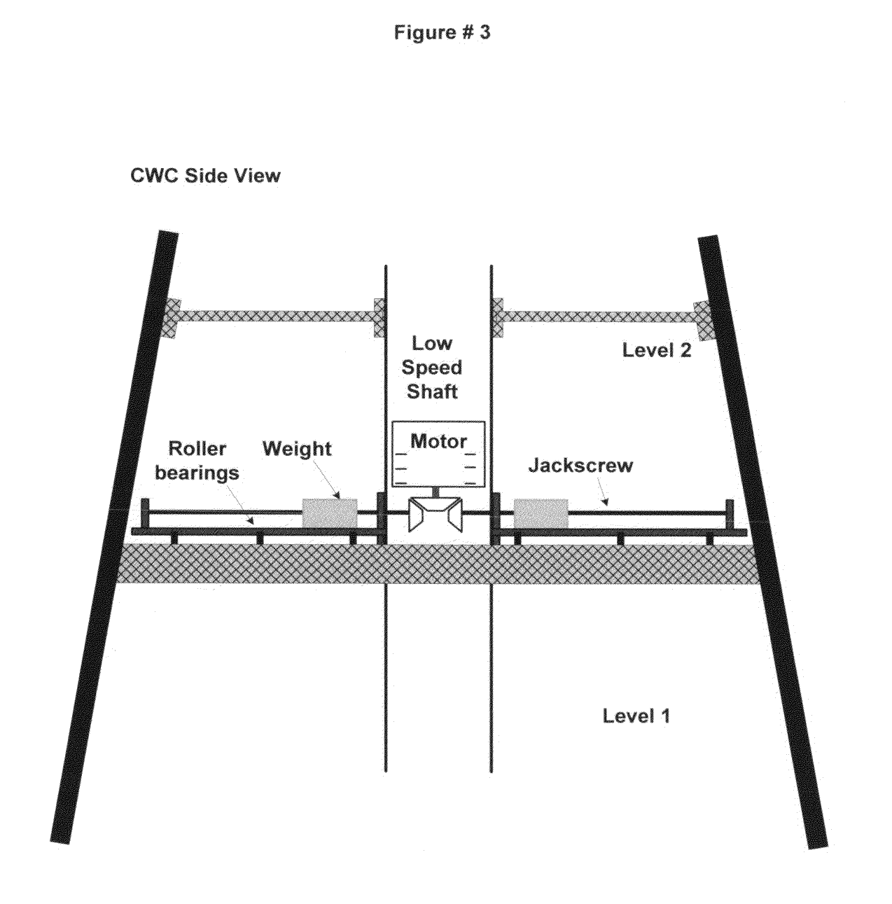

This fixed pitch wind (or water) turbine makes use of a patented (U.S. Pat. No. 6,949,842) control solution know as “Centrifugal Weight Control”—or CWC. Such an implementation presents an opportunity to extend the low speed shaft down the length of the tower (wind turbine) or up above the water line (water turbine). See FIGS. 1 & 2 respectively.

In the wind implementation, extending the low speed shaft down the length of the tower also means you can move other major components down, including generator and gearbox. Doing so results in several compelling advantages as outlined below:
Significant reductions in top head mass (weight at top of tower) can be realized.
Moving the generator(s) to the base of the tower permits the use of a larger, heavier and less costly generator product.
At the base of the tower available space will accommodate a generator(s) having a greater number of pole pairs.
The need for lightweight technology employing rare earth elements will no longer be necessary.
More pole pairs in the generator will permit lower gear ratios in the gearbox (or transmission).
Economies in the built phase and ongoing operation and maintenance of the system will be realized.
An inherently stronger fixed pitch solution will accommodate increases in blade solidity. Solidity increases equate to increases in torque that, in turn equate to increases in power.

Employing CWC (in lieu of pitch or stall solutions) in conjunction with induction generator torque, enables on demand control of necessary amounts of opposing torque to manage rotor speed in gusty and increasing wind speeds through cut-out . . . typically 25 meters per second. The sum of opposing torques found in full extension of weights and generator(s) at rated power must be greater than rotor torque at 25 m/s.

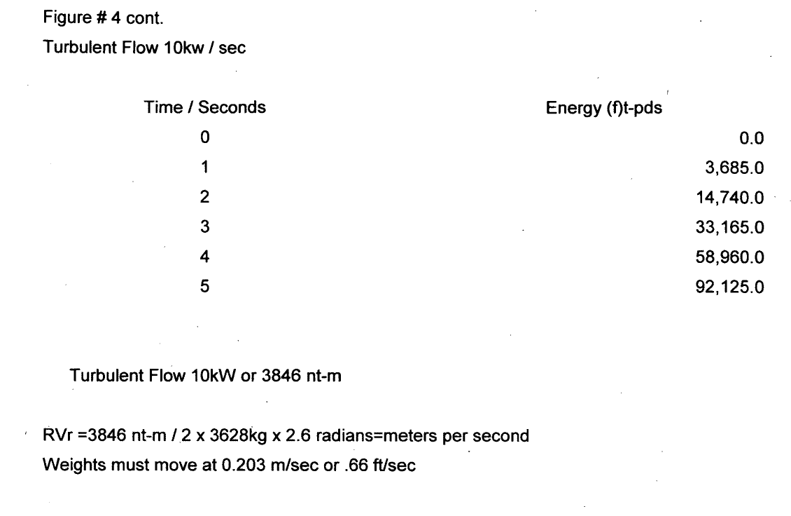

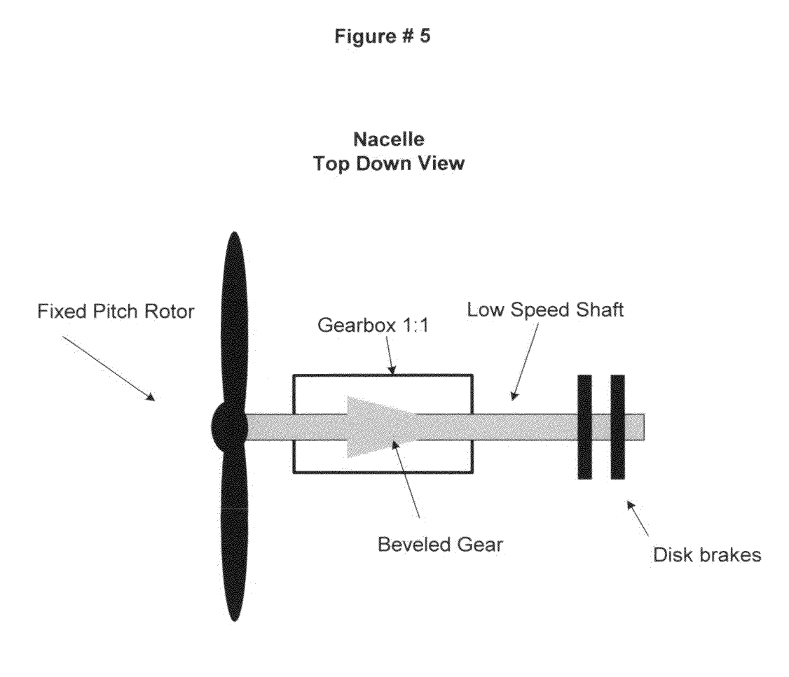

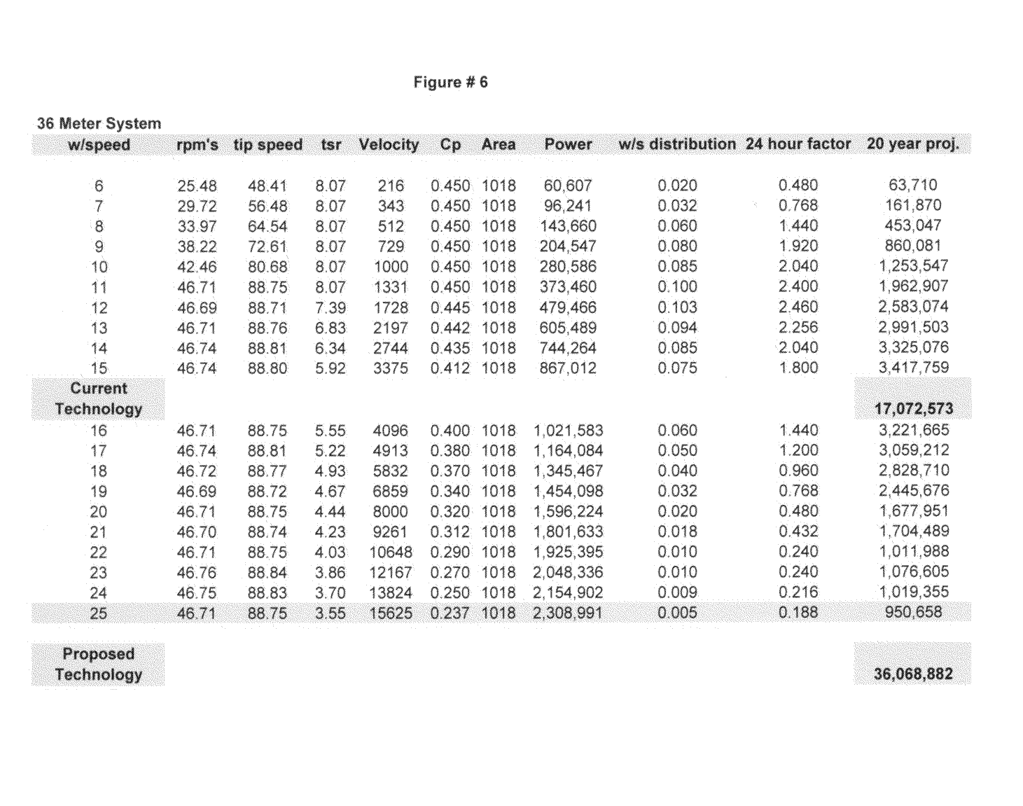

CWC will dampen and temporally store energy. FIG. 4 demonstrates storage capability of CWC with eight weights (each at 1000 lbs). Such temporary storage will relieve stresses currently known to damage gearboxes. Downtime and costly repairs or replacement can be avoided.

Under program control CWC will be used in response to two recurring operating conditions:
In response to wind gusts or turbulent flows (water), the plurality of weights on jackscrews in conjunction with generator torque will be employed to control rotor speed through 25 m/s (3.4 m/s water). Generator torque will increase only at a rate that the gearboxes can easily tolerate. This parallel extension of weights and use of generator torque will assure control of rotor speed and its rate of increase. When adequate control is achieved generator torque will be further increased to take additional energy from what is stored in the extended weights and accordingly the weights will retract.
CWC will control rotor speed while gear changes occur. CWC will temporarily displace generator torque (during disengagement) while the clutch operates for gear change.

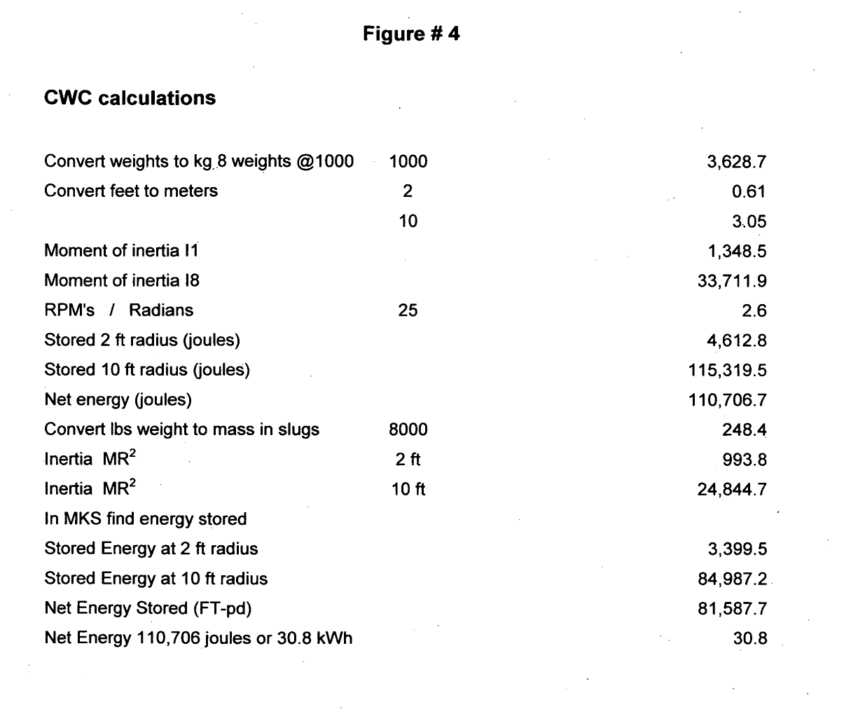

In both wind and water implementations the CWC configuration is horizontal (perpendicular to vertical low speed shaft). A rotating and circular guide/sled on roller bearings will be necessary to carry the CWC weights as they extend or retract for routine operation. See FIG. 3.

In the wind implementation stopping/parking the rotor at cutout will employ both yaw and conventional brakes.. In the water implementation yaw may be used to reduce load, but braking to overcome rotor forces will not be employed. When flows in excess of 3.4 m/s are encountered the rotor and low speed shaft will disengage from generator (via clutch) and weights will fully retract. Rotor will turn freely until normal operating conditions return.

In both wind and water implementations a vertical chassis integral to tower or monopile, will be necessary to carry vertical and lateral loads of the low speed shaft.

Clutch operation for gear changes will be under program control. This control will extend or retract weights to control rotor speed and manage generator speed while disengaged to accommodate a gear change. Gear changes will routinely occur to maintain desired generator rpm's across the distribution of operating wind speeds. Same control will be applied to the water turbine.

Centrifugal weight control, fixed pitch, an extended low speed shaft and transmission distinguish the discussed solution from present day wind and water turbines.

1. A wind (water) turbine power generating assembly comprising:
a fixed pitch blade/rotor assembly;
an extended low speed shaft with 1:1 gearbox for 90° turn;
a centrifugal weight control assembly;
a clutch and transmission assembly in lieu of traditional gearbox;
an assembly at the tower base including CWC, transmission, and generator(s);

2. Apparatus as set forth in claim 1;
wherein increasing amounts of power will be generated in the 15 to 25 m/s range for wind and the 2.4 to 3.4 m/s range for tidal (bi-directional flow);
wherein optimized tip speed ratio can be maintained for the entire operating range of the flow (wind or water).

3. Apparatus as set forth in claim 2;
wherein initial build and ongoing operational and maintenance costs will be significantly less than current technology.
